(19) United States
(12) Patent Application Publication
(10) Pub. No.: US 2008/0294543 A1
(43) Pub. Date: Nov. 27, 2008

(54) Software product and system for facilitating real estate transactions

(76) Inventor: Sean Shebby, San Francisco, CA (US)

Correspondence Address: Benjamin I. Edlavitch, PO BOX 220661, Chicago, IL, 60622-0661, US

(21) Appl. No.: 11/807,276

(22) Filed: May 25, 2007

(51) Int. Cl. G06Q 40/00

(52) U.S. Cl. 705/37

(57) ABSTRACT

A software product and system that facilitates real estate transactions. More specifically the software product and system allow users to bid on a variety of terms and conditions to a real estate agreement. The software product and system also allows a user to make a bid via a remote computing device.

### BACKGROUND

The pricing of real property is not an exact science. Despite market forces, there is a great deviation in pricing of similar situated real estate. One factor creating this situation in the real estate market is the relatively limited influence buyers have on price of real property. In addition, conventional forms of pricing real estate often ignore what buyers are willing to pay for a property, causing the price of the property to be uncompetitive. Auctioning real estate resolves these issues.

Auctioning real property provides for more buyer influence and increases competitiveness in pricing real estate. By definition, an auction allows buyers to direct the price of a property. In addition, auctioning real estate allows for more competitive bids than conventional means of selling property, because multiple buyers make multiple bids on a property. Oppose to one buyer making an offer on a property.

In in-person auctions, where participants of an auction are at one location, bids remain competitive and parties can freely communicate transactional information. For example, auctions allow parties to exchange information on the status of a bid, allow for explanations of rejected offers, and provide for the addition of terms and conditions to a real estate agreement. Moreover, allowing for the bidding on contingencies (i.e. conditions to an agreement), provides the buyer with a choice to perform necessary due diligence in the way of inspections of a property. In summary, in-person auctions allow for more informed and competitive bidding.

Besides in-person auctions, remote auctions are available to buyers and sellers of real estate. Remote auctions differ from in-person auctions in that participants need not be at the same location. With an ability to make the location of an auction flexible for bidders, bidders from different geographic regions are more likely to bid on a property. Because of this flexibility and the advent of e-commerce, remote auctioning in real estate has become more popular in the last decade.

With this said, there are major drawbacks to remote auctioning. As of today, remote auctioneers auction property on an “as is” basis. In other words, buyers and sellers of real property cannot transact on a contingency basis when participating in a remote auction.

The deficiency in remote auctioning is probably due to the lack of software available for more complex real estate transactions. A handful of software products allow for remote auctions; however, if contingencies are included in a real estate agreement facilitated by a contemporary product, the contingencies usually exist prior to bidding.

One of the great advantages of an in-person auction over a remote auction is that sellers can add or change contingencies before or after bidding commences, which allows sellers to respond to demand. Not having the ability to negotiate contingencies greatly limits the bartering power of all parties in an auction. For example, contingencies such as the right to inspection and sale contingent upon sale of other property become nonexistent. Even terms of a real estate agreement, such as an initial deposit, are nonnegotiable in contemporary remote real estate auctioning. By limiting the variables that parties can agree upon in a real estate transaction, the transaction is much less likely to meet the demand of buyers.

Naturally, the limits of remote auctioning have lessened its use. Parties for the most part use traditional methods of transacting real estate or use in-person auctioning. Alternatively, a software product that facilitates auctioning of real estate that allows parties to remotely bid on the details of a real estate agreement might increase the use of remote auctioning; especially considering the benefits of remote auctioning.

### SUMMARY OF THE INVENTION

Described in this application is a software product and system that facilitates real estate transactions, incorporating the benefits of in-person real estate auctions and negotiations. In a preferred embodiment, the software product and system allows users to make bids on real property, including bids on the terms and conditions (i.e. contingencies) of a real estate transaction associated with the property. In a preferred embodiment, the software product and system also facilitate feedback from sellers to users and facilitate the display and execution of a real estate agreement.

### BRIEF DESCRIPTION OF THE DRAWINGS

Below is a description of embodiments of a software product and system that facilitate real estate transactions in conjunction with appended drawings, wherein like reference numerals refer to like elements in figures, and wherein:

FIG. 1 (labeled “FIG. 1” in the drawings) is a diagram of an example system that employs a software product that facilitates real estate transactions, which provides the ability to bid on real property and multiple attributes of a real estate agreement associated with the property;

FIG. 2 (consists of three pages labeled “FIG. 2, Page 1 of 3,” “FIG. 2, Page 2 of 3,” and “FIG. 2, Page 3 of 3” in the drawings) is a diagram of an example procedure employed by a software product and system that facilitates real estate transactions where a user has the ability to bid on real property and multiple attributes of a real estate agreement associated with the property; and

FIG. 3 (labeled “FIG. 3” in the drawings) is a diagram of an example procedure employed by a software product and system that facilitates real estate transactions, where a seller or agent of a seller has the ability to add real property to a system that facilitates real estate transactions.

### DETAILED DESCRIPTION

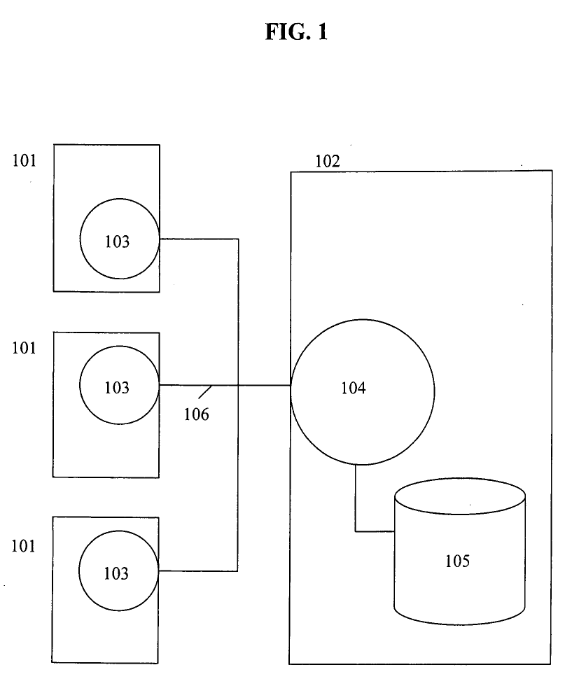

### Detailed Description of FIG. 1

FIG. 1 shows an example system that employs a software product and system that facilitates remote real estate transactions that provides the ability to bid on real property and multiple attributes of a real estate agreement associated with the property, which includes: a remote computing device(s) 101 for accessing a host computer(s) (i.e. server(s)) 102; software 103 employed by a remote computing device 101 that facilitates making responses and requests to the server 102; software 104 employed by the host computer 102 for making responses and requests to the remote computing device 101; and software 104 employed by the host computer 102 or software 103 employed by the remote computing device 101 for storing, controlling, or presenting data. The remote computing device 101 and host computer 102 communicate via a network 106 using any known network protocol. A database 105 warehouses the user and real estate transaction information 105.

In FIG. 1, a remote computing device 101 can be a personal computer, laptop, handheld mobile computing device, or mobile telephone. In addition, a remote computing device 101 can have an audio user interface, a visual display, or the combination of audio and visual displays.

In a preferred embodiment, a host computer 101 can be any known computing device that is capable of hosting a web application server and a database management system. The host computer 101 can be comprised of multiple computing devices that work interchangeably (i.e. a cluster) or a single computing device. The host computer 101 comprises a modem and an operating system.

In FIG. 1, software 103 comprises computing device instructions stored in a computing device readable medium. Software 103 facilitates real estate transactions.

In FIG. 1, software 104 facilitates storage and administration of user information and real estate transaction information on a server 102. In a preferred embodiment, the user and real estate transaction information is stored in a database 105. It is also preferred that a database management system that communicates with the software 104 administers the information stored by the database 105.

In FIG. 1, software 104 facilitates communication of the information to a remote computing device 101 via a network 106. In a preferred embodiment, a web application server hosts the software 104.

In FIG. 1, software 103 employed by a remote computing device 101 facilitates receiving and handling of the user and real estate transaction information that the server 102 communicates via the network 102. In a preferred embodiment, the software 103 interacts with a web browser employed by the computing device 101.

In FIG. 1, software 103 facilitates a user interface presented by the remote computing device 101 that allows entering, changing, and displaying the user information and real estate transaction information. In a preferred embodiment, a web browser presents the user interface.

In FIG. 1, software 103 facilitates communication of the user and real estate transaction information to the server 102 via the network 106. In a preferred embodiment, the software 103 interacts with a web browser.

In FIG. 1, software 104 facilitates receiving and handling of the user information and real estate transaction information that the remote computing device 101 communicates to the server 102 via the network 106. In a preferred embodiment, a web application server collaborates with the software 104.

The network 106 illustrated in FIG. 1, is any type of network known to one of ordinary skill in the art, including, but not exclusively, a local area network, wide area network, a wireless network, and the Internet.

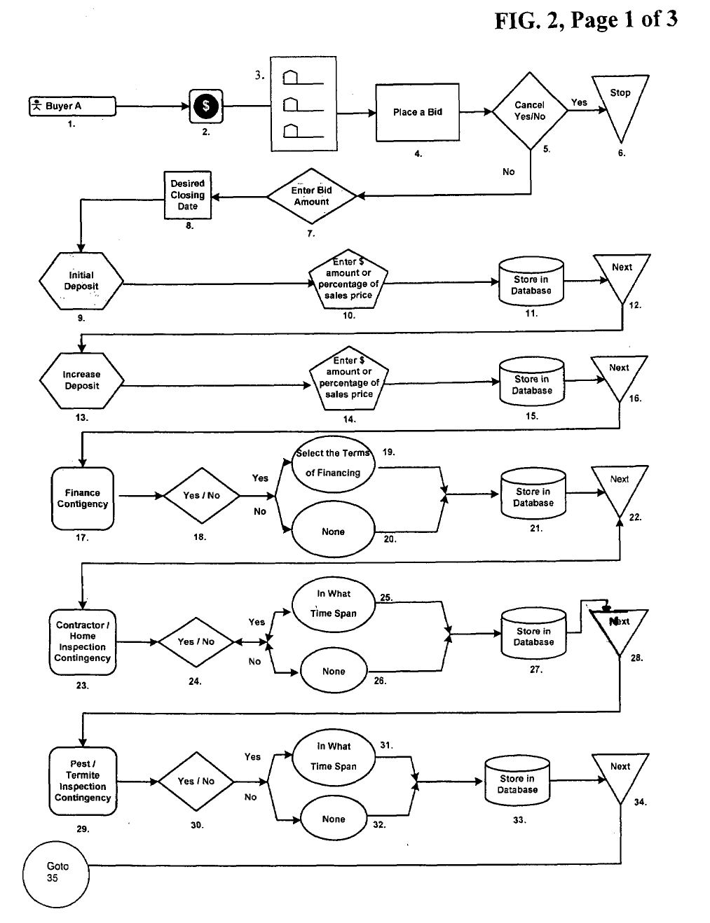

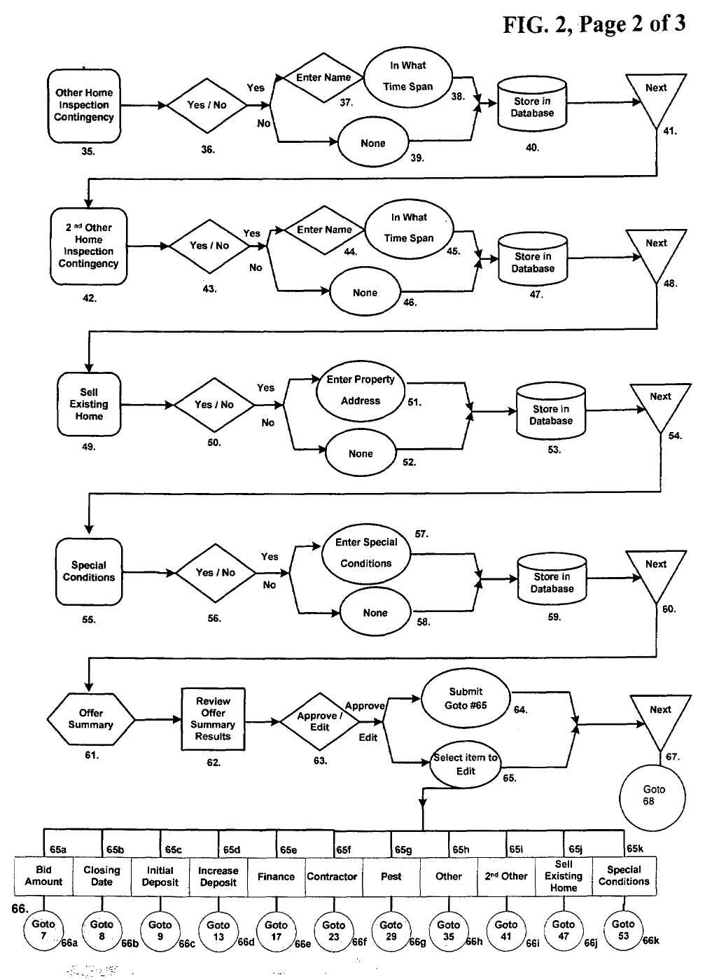

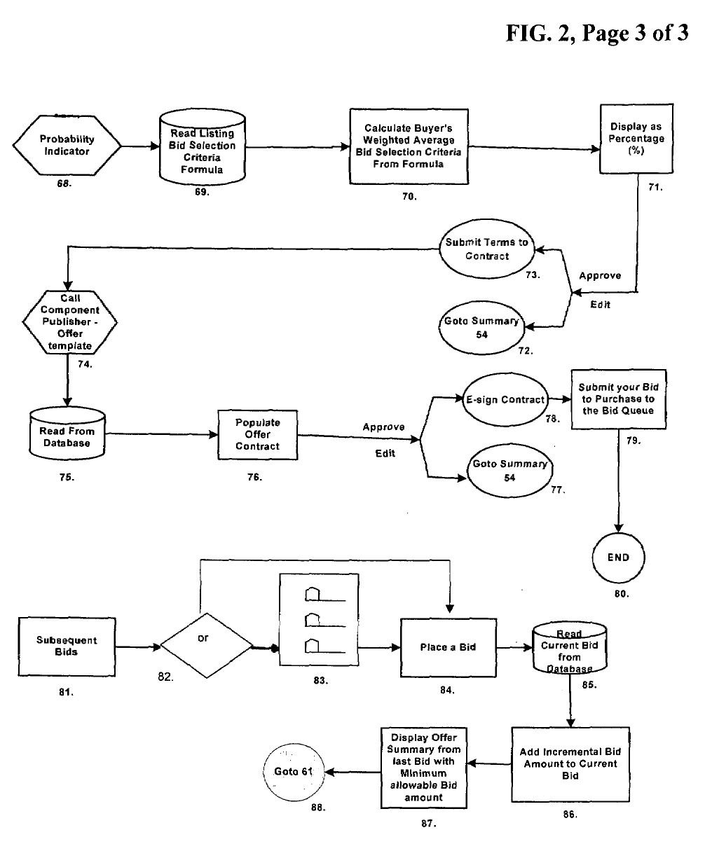

### Detailed Description of FIG. 2

The detailed description of FIG. 2 illustrates an example procedure in conjunction with FIG. 2, where steps incorporated by a system, employing a software product, facilitate a real estate transaction. More specifically, the example procedure allows users (i.e. potential buyers, buyers, and agents) to bid on terms and conditions (i.e. contingencies) of a real estate transaction.

First, the system presents a login user interface to a user 1. The user typically logs into the system by entering a user name and password stored in a database. Next, a user interface presents the current balance of cash available to the user 2.

Next, a user interface presents a list of real estate stored in the system 3. The display of property includes a display of information associated with each listed property. The information displayed includes a current bid amount, a bid increment amount, a starting price, and information on satisfaction of a reserved price. A user when presented the list of properties has the ability to select a property 3. Upon selection of a property, a user interface allows the user to choose to bid on the property 4 or cancel 5 the property selection. In FIG. 2, the system ends the procedure for the selected property 6 upon the cancellation. In a preferred embodiment, the cancellation results in the system presenting a user interface that gives a choice to the user on how to continue.

After the user selects a property to bid on and does not cancel the selection, the user enters a bid amount 7. In a preferred embodiment, a minimum bid amount is automatically calculated (previous bid plus the bid increment amount) and presented to the user. Next, the system presents the user with an ability to enter a closing date 8. In a preferred embodiment, the user can select a date from a calendar user interface.

Subsequent to entering the closing date, the system provides a user interface that allows the user to enter an initial deposit 9. The user can enter the initial deposit as a percentage of the purchase price or a dollar amount 10. In a preferred embodiment, the system automatically calculates a dollar amount for the deposit after the user enters a percentage. After the user enters the deposit amount 10 the system stores the amount in a database 11.

Next, the system presents a user interface that allows the user to change the amount for the initial deposit 12. The user can increase or lower the amount as a percentage of the purchase price or a dollar amount 13. In a preferred embodiment, the system automatically calculates a dollar amount for the deposit after the user enters a percentage 14. After the user accepts the change in the deposit, the system stores the change in a database 15.

Subsequently, the system provides the user with an ability to select financial contingencies 16 & 17, including the option to purchase contingent upon securing financing 18 & 19. In a preferred embodiment, if the user selects the option to purchase contingent upon securing financing, the system presents a user interface that requests terms of financing, including loan type, loan amount, term of loan, interest rate, and points 19. If the user does not select for the contingency, the system stores this choice in a database 20. If the user selects the contingency then the system will also stores this information in a database 21.

Next, the system provides the user with an ability to select contingencies based on inspections of the real property 22, 23, 24, 25, & 26, and an ability to store the selection in a database 27.

After the previous choice, the system provides the user with an ability to select contingencies based on pest and/or termite inspections 28, 29, 30, 31, & 32, and an ability to store the selection in a database 33.

In addition, the system can provide the user with an ability to select other foreseeable inspection contingencies 34, 35, 36, 37, 38, 39, 40, 41, 42, 43, 44, 45, & 46, and an ability to store the selections in a database 47.

Next, the system provides the user with an ability to select a purchase contingent upon selling of other real property 48 & 49. If the user decides to request such a contingency, the system will request that the user enter the address of the other property 50 & 51. Then the system stores in a database the user's affirmation of the contingency 53. If the user does not select the contingency 52, the system stores this information in the database as well 53.

Following the previous choices, the system provides the user with an ability to select special contingencies or other foreseeable contingencies of a real estate agreement not mentioned in previous steps 54, 55, 56, 57, & 58. As in prior steps, the system has the ability to store input from the user in a database 59.

In a preferred embodiment, transactional software employed by the system allows for intermediate storage of all the data the user enters in previous steps. This intermediate storage preserves the integrity of the data until further storage of the data in a database. In other embodiments, the system can store and administer the user and real estate transaction information by any known method to those of ordinary skill in the art.

The order in which the user or agent selects or enters contingencies and the order that these contingencies are stored in a database can vary per embodiment. In other embodiments, the system can leave out the ability to select the specified contingencies or add the ability to select other contingencies.

After the system makes available the entry of contingencies and terms of a real estate agreement, the system presents a summary of terms and conditions selected by the user 60, 61, & 62. From the summary presentation the user can choose 63 to approve 67 or edit 64, 65, 65a, 65b, 65c, 65d, 65e, 65f, 65g, 65h, 65i, 65j, & 65k the terms and conditions by returning to previous steps 66, 66a, 66b, 66c, 66d, 66e, 66f, 66g, 66h, 66i, 66j, & 66k.

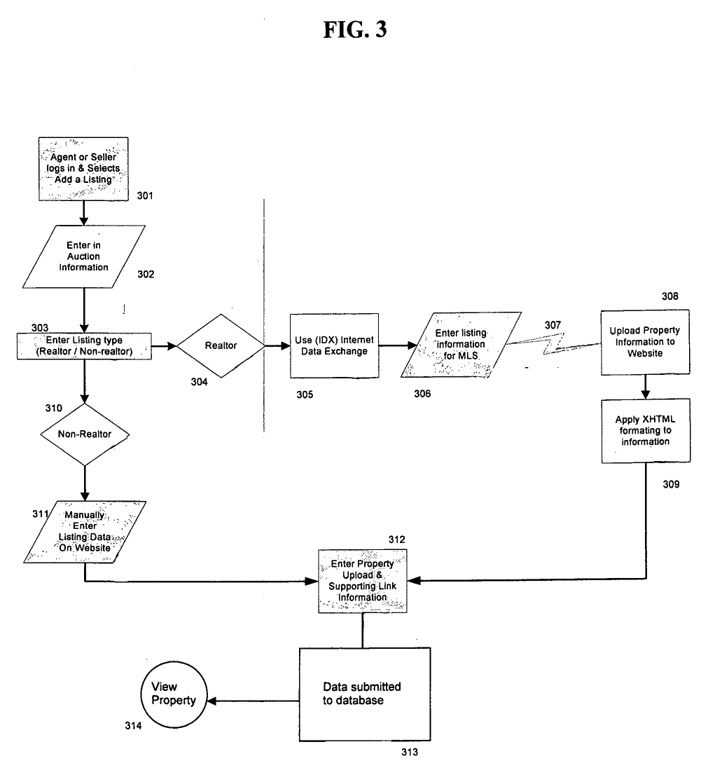

After the system provides the choice to edit contingencies and any other terms found in a real estate transaction, the system provides the user with a probability that a seller (i.e. seller or seller's agent) will accept the offer 67. The system calculates the probability from a bid selection criteria (see “Detailed Description of FIG. 3” for more information on the bid selection criteria) entered into the system by the seller 68. In a preferred embodiment, the system retrieves from a database the bid selection criteria entered by the seller 69 (See “Detailed Description of FIG. 3”).

In one embodiment, the system applies ratings entered by a seller (described in “Detailed Description of FIG. 3”) to calculate the probability of the seller accepting the offer 70. In a preferred embodiment, the system displays a graphical representation of the probability 71.

In addition to making changes to terms and conditions prior to the calculation mentioned in the previous two paragraphs, a user has the option to make changes after the calculation. If the user chooses to edit terms and conditions after the calculation 72 the system will loop the user back to the user interface that displays the summary of the selected terms and conditions 62.

After a user finalizes his or her offer, the system allows the user to submit it 73. Subsequent to submission of the offer, the system calls software that displays a template of a real estate agreement in a read-only format 74. Next, the system selects from a database(s) the real estate transactional information and user information entered by the user 75. The system then populates the template with the user and transactional information and displays a complete real estate agreement 76. After the previous step, the user can choose to edit the agreement 77 or approve it.

If the user chooses to approve the agreement, the system provides the user with a method for authenticating and signing the agreement. In a preferred embodiment, the user signs the agreement via a password protected e-signature file 8. After authentication, the system submits the agreement to a queue and stores the data associated with the executed agreement in a database 79. In a preferred embodiment, the system submits data associated with the agreement to a queue as well. The data submitted can include bid amount, bid status, and a timestamp of the submission of the agreement.

After complete submission of the agreement, the system presents an acknowledgement to the user that the offer associated with the agreement is successfully submitted 80. In a preferred embodiment, the acknowledgement of a successfully submitted offer can take a form chosen by the user.

After completing a bid, a user can place a subsequent bid 81. The system gives the user the option 82 to enter a bid on a new property via a listing of properties 83 & 84, or place a new bid on the same property 84. The system then proceeds by selecting from a database the current bid on the selected property 85, incrementing the appropriate amount to the current bid 86, displaying the new bid to the user 87, and providing the user with an ability to bid on other terms and conditions 88.

### Detailed Description of FIG. 3

The detailed description of FIG. 3 describes an example procedure in conjunction with FIG. 3, which illustrates steps incorporated by a software product and system that facilitates a real estate transaction. More specifically, the example procedure illustrates a system implementing software that facilitates the adding of real estate to the system by a seller (i.e. seller or seller's agent). This description comprises a number of steps that reference like elements in FIG. 3.

First, a seller logs into the system and selects a graphic that displays “Add a listing” 301. Next, the system provides the user with the ability to enter seller and real estate transaction information, including listing title, auction type, starting price, reserved price, takeaway price, and bid increment amount 302. In a preferred embodiment, a user can rate the importance of each field of information. The rating system employed by a preferred embodiment of the system affects the order that the system lists a property, associated with the information, to a user (i.e. buyer, prospective buyer, or agent).

Next, the seller enters his/her status as a realtor or non-realtor 303, 304, & 310. If the seller enters that he/she is a realtor then the system employs Internet Data Exchange (known as IDX) 305 to facilitate entering listing information of the property, which comes from Multiple Listing Services (known as MLS) 306. Subsequently, the system tests the connection with MLS 707, and if properly connected, uploads the relevant property information and other associated real estate transaction information 308. In a preferred embodiment, system applies XHTML formatting to the uploaded information 309.

If seller is a non-realtor 310 then the system allows the seller to manually enter real estate transaction information 311. In addition, the seller can upload images or videos of the property, documents associated with the property, URLs that market the property, property statements, and bid criteria 312. Realtors can also upload the previously described data and files 312.

After a realtor or non-realtor submits the real estate transaction information to the system, the system stores the information 313, preferably in a database.

Once the user enters required information for a property and submits this information to the system, the property associated with the information is viewable to any user, seller, or agent that has access to the system 314.

1. A software product for facilitating real estate transactions comprising, in combination:
computing device instructions, stored in a computing device readable medium, that facilitate storage and administration of user information and real estate transaction information;
computing device instructions, stored in a computing device readable medium, that facilitate communication of the user information and the real estate transaction information between computing devices via a network;
computing device instructions, stored in a computing device readable medium, that facilitate receiving and handling of the user information and the real estate transaction information; and
computing device instructions, stored in a computing device readable medium, that facilitate entering, changing, and deleting the user information and the real estate transaction information.

2. The software product of claim 1, wherein the user information comprises a username, a password, and a user's cash balance.

3. The software product of claim 1, wherein the real estate transaction information comprises an asking price of real property and information describing the property.

4. The software product of claim 3, wherein a user interface allows a user to upload files containing the information describing the property and other real estate transaction information.

5. The software product of claim 4, wherein the files include image files, video files, audio files, text files, HTML files, and XML files.

6. The software product of claim 3, wherein the real estate transaction information comprises a closing date, a deposit amount to secure an offer on the property, a listing title, an auction type, a starting price, a reserved price, a takeaway price, a current bid amount, a bid increment amount, and conditions to a real estate agreement.

7. The software product of claim 6, wherein the conditions to a real estate agreement comprise an option to purchase contingent upon securing financing.

8. The software product of claim 6, wherein the conditions to a real estate agreement comprise an option to purchase the property based upon selling of other real estate.

9. The software product of claim 6, wherein the conditions to a real estate agreement comprise an option to purchase the property based on inspection of the property.

10. The software product of claim 9, wherein the inspection comprises a pest inspection.

11. The software product of claim 1, wherein computing device instructions, stored in a computing device readable medium, facilitate securing the user information and the real estate transaction information;

12. The software product of claim 1, wherein computing device instructions, stored in a computing device readable medium, facilitate prioritizing fields of the real estate transaction information.

13. The software product of claim 12, wherein: computing device instructions, stored in a computing device readable medium, facilitate calculating a probability that a seller will accept an offer for the property based on the prioritization of the fields of the real estate transaction information; and computing device instructions, stored in a computing device readable medium, facilitate communicating the probability to a user.

14. The software product of claim 1, wherein computing device instructions, stored in a computing device readable medium, facilitate presenting of a real estate agreement that comprises parties to the agreement, the parties' addresses, and other fields of the user information and the real estate transaction information.

15. The software product of claim 14, wherein computing device instructions, stored in a computing device readable medium, facilitate executing the real estate agreement.

16. A system that implements a software product for facilitating real estate transactions, comprising in combination:
a server;
a remote computing device;
a network;
the software product comprises computing device instructions stored in a computing device readable medium;
the server employs the software product to facilitate storing and administering user information and real estate transaction information;
the server employs the software product to facilitate communicating the user information and the real estate transaction information to the remote computing device via the network;
the remote computing device employs the software product to facilitate receiving and handling the user information and the real estate transaction information;
the remote computing device employs the software product to facilitate presenting a user interface for entering, changing, and deleting the user information and the real estate transaction information;
the remote computing device employs the software product to facilitate communicating the user information and the real estate transaction information to the server via the network; and
the server employs the software product to facilitate receiving and handling the user information and the real estate transaction information.

17. The system of claim 16, wherein:
the user information comprises a username, a password, and a user's cash balance;
the real estate transaction information comprises an asking price of real property, information describing the property, a closing date, a deposit amount to secure an offer on the property, a listing title, an auction type, a starting price, a reserved price, a takeaway price, a current bid amount, a bid increment amount, and conditions to a real estate agreement;
the conditions to a real estate agreement comprise an option to purchase contingent upon securing financing;
the conditions to a real estate agreement comprise an option to purchase the property based upon selling of other real estate; and
the conditions to a real estate agreement comprise an option to purchase the property based on inspections of the property;
the user interface allows for a seller to upload files containing the information describing the property and other real estate transaction information; and
the files comprise image files, video files, audio files, text files, HTML files, and XML files.

18. The system of claim 16, wherein:
the software product comprises computing device instructions, stored on a computing device readable medium, to facilitate securing of the user information and the real estate transaction information.

19. The system of claim 16, wherein:
the software product allows a seller to prioritize fields of the real estate transaction information;
the software product facilitates calculating a probability that the seller will accept an offer on the property from a user based on the prioritization of the fields of the real estate transaction information; and
the software product facilitates communicating the probability to the user.

20. The system of claim 16, wherein:
the user interface presents a real estate agreement comprising parties to the agreement, the parties' addresses, and other fields of the user information and the real estate transaction information; and the user interface allows for the execution of the real estate agreement.
